(19) United States
(12) Patent Application Publication
(10) Pub. No.: US 2002/0112048 A1
(43) Pub. Date: Aug. 15, 2002

(54) System and method for providing behavioral information of a user accessing on-line resources

(76) Inventors: Francois Gruyer, Saint-cloud (FR); Pierre Dupuis, Paris (FR)

Correspondence Address: BAKER & MCKENZIE, 805 THIRD AVENUE, NEW YORK, NY, 10022, US

(21) Appl. No.: 09/734,304

(22) Filed: Dec. 11, 2000

(51) Int. Cl. G06F 15/173; G06F 15/16

(52) U.S. Cl. 709/224; 709/218

(57) ABSTRACT

A system and method for monitoring usage or user behavior when using resources over a network, e.g., a behavioral information of a web user browsing web pages on selected web sites is provided. The behavioral information is stored and is available for further analysis. When a user visits a web site, the user is given an option to download and install an agent program. The agent program monitors the user's behavior on selected web sites and uploads the behavioral information to a server. The server collecting the information is typically not related to the web sites being monitored. The behavioral information is provided from the agent to the server with a least amount of intrusion on the user device resources and at the same time protects the user identity and privacy. The behavioral information may be provided to any entity interested in knowing user's behavior on a selected list of web sites. At any point in time the user has total control over the collected information, the user can visualize what has been collected so far, exit from the panel permanently or temporarily. The user that agrees to download the agent program on the user's device may be rewarded the agent via various incentives and accesses to privileged on-line services and resources.

### TECHNICAL FIELD OF THE INVENTION

The present invention is directed to computer systems in general, and in particular, to a system and method for monitoring and/or providing behavior of a user using a user interface to access resources and services, e.g., on the World Wide Web.

### BACKGROUND OF THE INVENTION

The development of the World Wide Web (“web”) and its associated technologies have created deep transformation of the Information Technology (“IT”) infrastructure and tremendous business opportunities between companies and their customers including individual consumers as well as other companies in the supply chain such as suppliers or distribution channels.

Electronic-commerce (“E-commerce”) also closely related to the World Wide Web is developing rapidly in the business to business (“B2B”) interactions such as procurement, E-bidding, sourcing, as well as in business to consumer type of transactions. As of today, numerous examples have emerged to prove the effectiveness of E-commerce in various activities, showing some E-commerce companies successfully leveraging web and Internet based technologies to transform their business.

Because E-commerce is enabled typically via the web interface, e.g., a web browser, it is important that these businesses tailor their web sites most efficiently and conveniently to attract as many users as possible for their businesses. For example, most if not all of the E-commerce initiatives rely on a client side web browser, a unique application that presents a variety of information such as text, images, video, and music, various forms for interaction, and on-line service access. In this context of web browser based interactions, obtaining responses to some simple questions become a key to a good business.

An example of relevant information needed for the businesses include whether or not a user, consumer, channel partner, or supplier representative that connects to the web based service is experiencing an acceptable performance, e.g., in terms of speed at which web pages are loaded, and interactions are responded. Other examples include a typical behavior of web users that use the web service; the type of customers, the interest of typical customers visiting the web service; navigation patterns of people consulting or using the web service; the method the user used to enter the web site providing the web service.

This type of information is valuable not only to the businesses hosting or providing the web services but also to those businesses interested in the quality and state of competitors' services. Surprisingly, however, there presently is no easy method for obtaining such information. The existing businesses who focus on Internet audience measurement and analysis include, among others, Netvalue, Mediametrix, Webtrends, Websidestory, Keynotes, and Netratings. Netvalue and Mediametrix provide a panel oriented approach, however, the information collected is directed not specifically to a web navigation behavior, but to all Internet Protocol (“IP”) traffic for the user. Moreover, the panel technology employed by these businesses is very intrusive and cannot be applied easily in corporate environments. Webtrends, a well known vendor in the area of web server centric monitoring, and Keynotes, offering an outsourced service to monitor web sites URLs from the outside, also do not provide detailed navigation behavior of users browsing the various web pages.

Websidestory monitors user behavior by using a hidden loaded component that a user is typically not aware of. Other log and analysis tools are provided currently by Net.genesis (Nel.analysis.pro), Active Concepts (Funnel Web), Accrue Software Inc. (Hit list pro), and Allstats4you SA. The log analysis tools offered by these companies, however, do not monitor at a user workstation level, sacrificing accuracy, e.g., because of proxy cache effect that prevents systematic page reload by a user from the web server; they do not provide monitoring at the individual page frame or component level for detailed monitoring.

Therefore, it is highly desirable to have a system and method to monitor the user behavior on the web in finer detail and provide such information to the businesses interested in such information, e.g., those who host and/or own the web services as well as those who are interested in knowing user behaviors on the World Wide Web for other reasons.

### SUMMARY OF THE INVENTION

The present invention is directed to a method and system for analyzing the detailed behavior of the users browsing the World Wide Web. The behavioral information may be provided to businesses interested in knowing how users behave when using certain web services.

An agent software may be downloaded and installed on user devices, e.g., a personal computer (“PC”), a PDA, a web phone, or any other device having a user interface and communication capacity for communicating in the World Wide Web. The agent software then monitors the usage on the web browser or an interface like the web browser for communicating to various web services. The user may fully enable or disable the agent software at any time as desired. The collected information is transmitted to a server location where the information may be stored. Typically a server is a remote computer servicing the agent software. The information may then be provided to various businesses interested in knowing the user behavior on their or other selected web sites such as their competitor's and/or affiliate's web services.

The web usage information collected includes, for example, the Uniform Resource Locator (“URL”) addresses visited, the precise times of such visits denoted as time stamps, the amount of time spent on each address, and loading time of a page into a browser. If the page contains frames, such information may be provided for each frame used or accessed by the user. Additional information may include the originating URL, whether or not the user is actively navigating the web page, whether or not the user is working in another application, whether or not the user prints or scrolls the pages.

In the present invention, protection of user privacy and identity is maintained throughout the monitoring session, i.e., users stay anonymous. The collected information generally does not provide a mechanism to locate or identify the users.

With the present invention, businesses may benefit by receiving information about the consumer behavior during the use of various web services which may or may not include their own. The up-to-date information may especially be useful to stay on the competitive edge in times of fierce market competition. The businesses, e.g., can use the information to their competitive advantage by using the information for their e-commerce performance benchmarking. The businesses can also use the information to strategically plan their business transactions.

In accordance with the goals of the present invention, there is provided an agent program that may be downloaded by a user. Once downloaded, the agent is installed and runs automatically on the user device. Alternatively, the agent program may have already been installed on the user device and may not need to be downloaded. When the user starts a web browser using the user device, the agent monitors and records the end-user behavior and utilization of the web browser. The agent also may send the monitored end-user behavior and utilization data to a remote server over a network.

The server collects the monitored data sent by one or more agents, and stores the data in a database. The server may include an analyzer program that data mines and analyses the content of this database. The analyzer may produce information reports in a form of web pages. The reports may be provided to the businesses that are interested in various user behavior on selected web services, which may or may not include their own web services, the web services of affiliates, and/or competitors.

Further features and advantages of the present invention as well as the structure and operation of various embodiments of the present invention are described in detail below with reference to the accompanying drawings. In the drawings, like reference numbers indicate identical or functionally similar elements.

### BRIEF DESCRIPTION OF THE DRAWINGS

Preferred embodiments of the present invention will now be described, by way of example only, with reference to the accompanying drawings in which:

FIG. 1 illustrates a general schema of the present invention in one embodiment;

FIG. 2 illustrates an example of screen display showing the information the users may access to check the information about its recent browser utilization;

FIG. 3 illustrates an example of a pop-up menu 300 displayable on the user device running the agent software;

FIGS. 4 and 5 are examples of the web page reports generated by the present invention in one embodiment;

FIG. 6 illustrates the design architecture of the system of the present invention in one embodiment;

FIG. 7 illustrates a multi-threaded architectural design of the present invention in one embodiment;

FIG. 8 is a block diagram illustrating the hooking mechanism in one embodiment of the present invention to detect and collect user interaction and navigation information from each running browser process;

FIG. 9 is a block diagram illustrating the navigation analysis algorithm in one embodiment of the present invention;

FIG. 10 is a flow diagram describing the process of allocating an anonymous user ID in one embodiment of the present invention;

FIG. 11 illustrates a panel configuration in one embodiment of the present invention; and

FIG. 12 illustrates an example schema of one or more servers and one or more agents handling one or more panel configurations.

### DETAILED DESCRIPTION OF THE PREFERRED EMBODIMENT OF THE INVENTION

The present invention is directed to a system and method for monitoring user interaction and navigation behavior of a user who is using one or more user interfaces that enable the user to interact with web services on the Internet. An example of such a user interface includes a web browser. An example of such web services includes files accessed from a user device via a URL of an Internet server. Throughout the description, these web files will be interchangeably referred to as web pages or web resources. Briefly, a URL is the address of a file (resource) accessible on the Internet. The type of resource depends on the Internet application protocol. The resource can be an HTML page, an image file, a program such as a common gateway interface (“CGI”) application or Java applet, or any other file supported on the web. The URL contains the name of the protocol required to access the resource, a domain name that identifies a specific computer on the Internet, and a hierarchical description of a file location on the computer.

A web site is a collection of web files which typically includes a beginning file called a home page. For example, most companies, organizations, or individuals that have web sites have a single URL address. This is their home page address. From the home page, other pages on their site can be accessed. A web server in this context is a computer that holds the files for one or more sites. A very large web site may reside on a number of servers located in many different geographic places. Web sites also may reside on a commercial space provider's server with a number of other sites that have nothing to do with one another. A web site may also be referred to as web presence which better expresses the idea that a site is not tied to specific geographic location. It is also possible to have multiple web sites that cross-link to files on each others'sites. This means that there can be more than one starting places or home pages for all the files.

The user device with which a user accesses the web resource may be any device capable of running an interface program, e.g., a web browser, to access the web pages provided via various URLs. Examples of a user device include but is not limited to PC, web phone, and PDA. In the descriptions herein below PC, workstation, desktop will be used interchangeably as an example of a user device for describing the invention, however, it should be understood that the present invention is not limited to using these devices as the user device.

The monitored information includes any type of user behavior and/or user actions performed by the user while the user is accessing the web pages. Examples of the information monitored include how different web pages visited, e.g., by a hyperlink or by directly typing a URL address, whether the user opened or accessed another application while the web page window was still open, scrolls, detailed navigation on the web browser, usage of the web browser, etc. This type of information will be referred from herein interchangeably as user behavioral information, behavioral information, monitored information, or the information.

In one embodiment, the monitored information may be collected in a database. For example, the monitored information may be transmitted from the user device to a remote server and stored in a database. Accordingly, the information is available in the database for anyone, e.g., businesses, enterprises, or companies interested having this type of information for various purposes. For example, a company desiring a better understanding of practices of other companies may request the information related to the user behavior on the web sites of those other companies. A business desiring to improve its own web site, e.g., may request the information related the user behavior on its own web site. In one embodiment, the information stored in the database may be data mined and/or analyzed and reports generated for providing to the businesses, enterprises, or companies.

In one embodiment, an entity such as a business, an enterprise, a company, or even an individual person may subscribe or request to receive the information. The entity may provide a list of web sites for which the information is desired. For example, the entity may be interested in the information associated with the web sites in the same line of business as the entity.

In one embodiment, the monitoring process starts when a user visits a web site owned or affiliated with an entity desiring the information or any web site affiliated with the system and method of the present invention. For example, when a user visits a web site that offers agent download service, the user is asked whether the user would like to be monitored during the user's web browser session when the user visits a selected set of web sites. If the user consents, the user is directed to a URL link from which monitoring agent software may be downloaded and installed on the user device. Alternatively, the agent software may already been installed in the user device and the user may not need to download the software.

When installed, the agent software typically has an access to the list of web sites where the user's actions or behavior will be monitored. Using the list, whenever the user visits or accesses any of the web sites listed in the selected set, the agent software monitors the user's web usage of these web sites and records user's behavior information.

To encourage users to consent to being monitored, an entity desiring to obtain the behavior information may optionally offer an incentive to the user. These incentives may be include discounts and/or coupons, and/or other useful information that are not typically available to the general public web users.

Once the agent is installed on the user workstation, behavioral information is monitored on the selected web sites and transmitted to a server where the information may be stored in a database. The server may be a central server located remotely from the individual user devices. The server may also be distributed among different geographic locations. The information then may be analyzed and provided to the entity requesting such information.

In one embodiment, the entity requesting the information need not be involved in the actual monitoring process or receipt and handling of the monitored information. For example, the entity provides a list of web sites that it would like the information gathered and receives the information, e.g., in a form of reports, periodically on a timely basis or at the time the entity make a request to receive such reports. The agent software installed on the user device sends the information to a server which stores the information in a central database, independent of the entity requesting the information or the web sites being monitored. Entity's minimal involvement drastically reduces the burden and cost that the entity may otherwise incur in maintaining a system and associated programs if it were to embark on obtaining the needed information on its own.

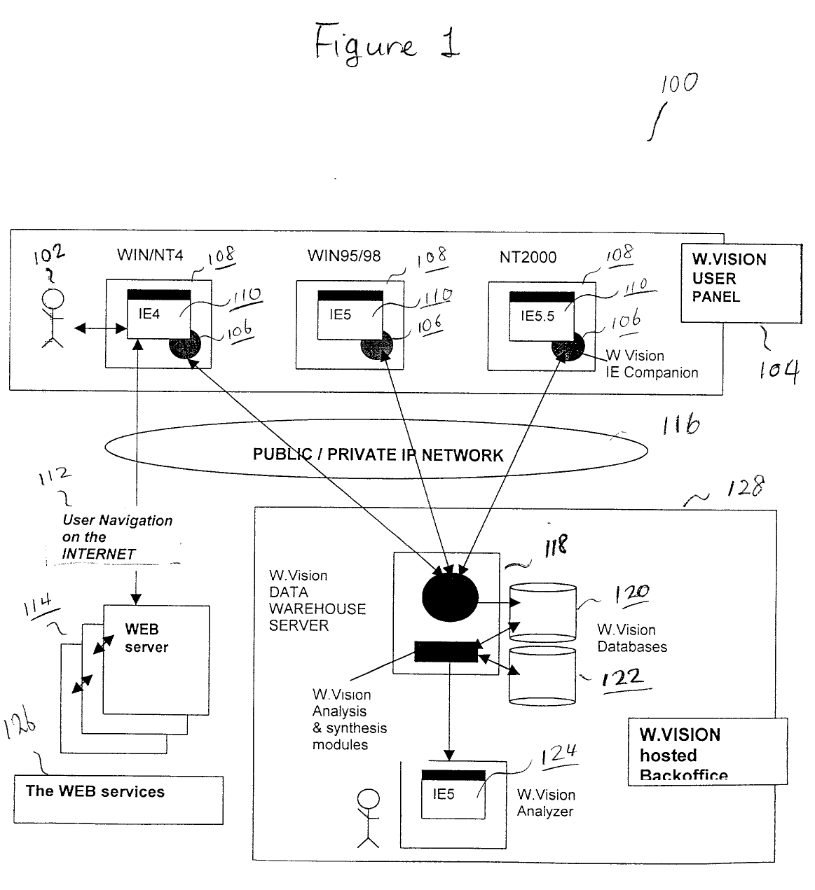

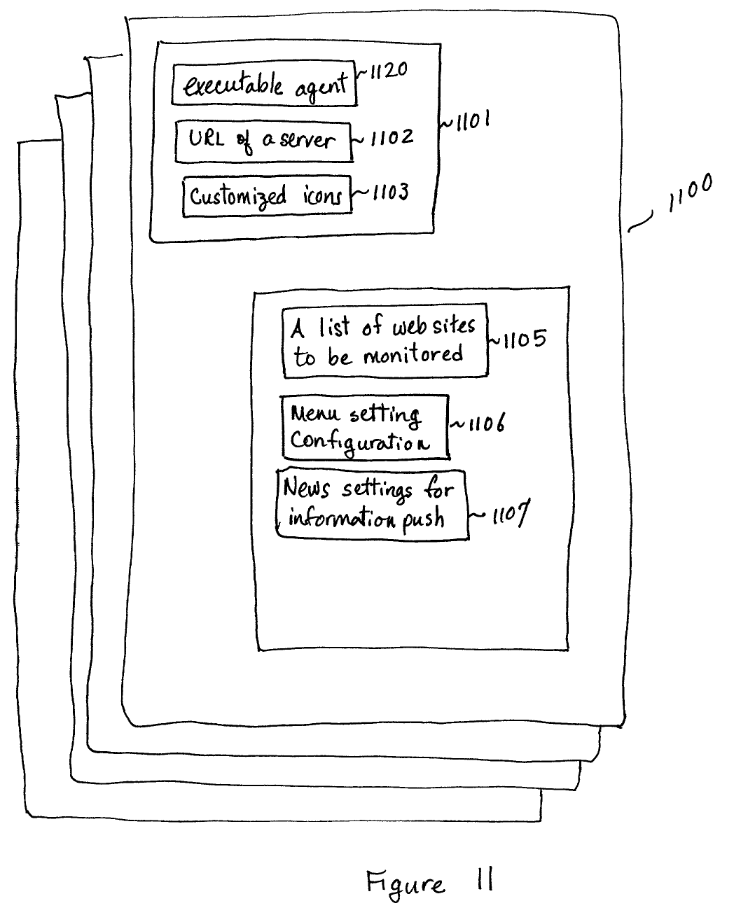

FIG. 1 illustrates an example of a general design schema 100 of the present invention in one embodiment. A user 102 is given an option to become a part of the user panel 104 or an “observation panel”. The user panel 104 or an “observation panel” refers to a list of users who have consented to being monitored to a same selected set of web sites. In one embodiment, a single user may belong to multiple user panels, i.e., one user may consent to being monitored on more than one selected set of web site. The concept of multiple user panels of the present invention will be described in greater detail with reference to FIG. 11.

Referring back to FIG. 1, when the user 102 consents to being monitored, the user is enabled to download and install the agent software 106 on a user device 108, e.g., a workstation or a desktop computer. The agent software 106 is typically an executable program that downloads and installs automatically with minimal user interaction. Once downloaded, the agent software 106 runs automatically to monitor and record the user actions and/or behavior as the user “surfs” or navigates the Internet 112 via a web browser 110, e.g., Internet Explorer(®). In one embodiment of the present invention, various types of user behavior or web usage are monitored for the selected or predetermined web sites 114.

The agent 106 monitors in detail the use of a web browser, e.g., Microsoft Internet Explorer(®), by a user 102 browsing the web pages provided by web services 126. In one embodiment, with a prior consent from the user 102, the agent 106 loads from the server 118 and self-installs automatically on a user's device 108, e.g., a PC or workstation. Once installed, the agent 106 activates itself automatically each time the user 102 opens a web browser 110 or starts the user device 108. The agent 106 does not requires a user administration and has a minimal impact on the user device in terms of central processing unit (“CPU”) overhead or disk and memory usage. The agent 106 monitors the user's web activities and transmits the monitored information using, e.g., a HTTP request in background mode, without any GUI interaction, on a predefined server URL.

In one embodiment, the agent 106 is configured to monitor the user's web activities on selected web sites. This set of web sites may have been selected, e.g., by a business entity interested in knowing the user's web usage particular web sites. These web sites may be owned by the business entity, affiliated with the business entity, and/or serviced by competitors of the business entity. The agent 106 provides, e.g., a pop up menu from which a user may access web pages or resources provided on these selected web sites. If a user visits web sites other than the selected web sites, the agent 106 does not monitor or record the user's usage on these non-selected web sites. The user also may view the list of web sites of which the user's usage are being monitored and recorded. In one embodiment, the user may also have the access to the collected information that is transmitted from the agent 106 to the server 118.

The agent 106 sends the monitored information, i.e., the user behavioral information, over a network to a server 118. As is well known to those skilled in the art, the communication may generally take place via the public and/or private Internet Protocol Network 116. The server 118 collects the user behavioral information sent by the agents 106. These observation data may be stored in a database 120. The server 118 also may include analyzer software or program that data mines and analyses the content of this database 120 and produces various reports. These reports may be in a form of a web page 124 and/or the reports may be stored in a separate database 122. The reports may be provided to the entities to be used for various business purposes.

In one embodiment, the monitoring in the present invention preserves the anonymity of the user 102, i.e., neither the server 118 collecting the information nor the entities receiving the reports can identify the user 102. For example, a unique arbitrary number may be generated in the server 118, and this number may be used on the server side to group together the received monitored information originating from the same user. No other user-identifying data is communicated to the server 118 from the agent 106. No cookies are generated by the method and system of the present invention for leaving any sort of track records of the user's usage. Moreover, the identification number is not generated using any attributes that could help to locate or identify the user, e.g., IP address, machine name, e-mail address, logon name, or any other data that is associated with the identity of the user. Consequently, the data warehouse of the server does not contain direct or indirect data on the users that are members of one or more observation panels.

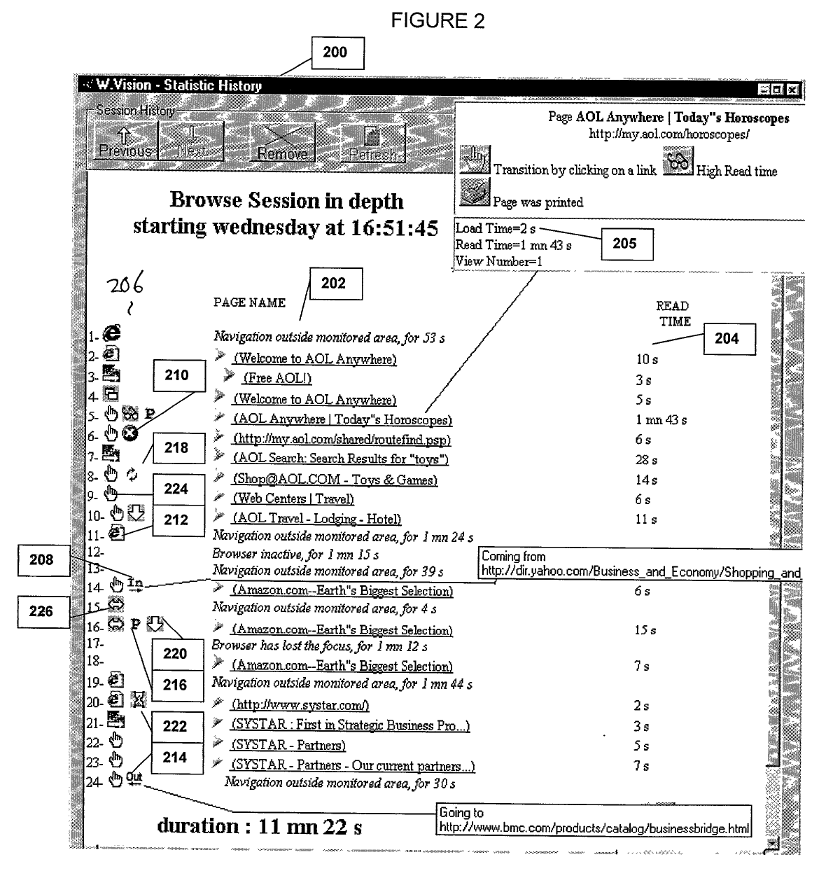

The agent 106 collects a unique set of behavioral information as users visit the selected web sites. FIG. 2 illustrates an example of screen display 200 showing the information the users may access to check what information about its recent browser utilization are actually kept in the server's database 120. As shown, the web usage is tracked in detail with the list of visited pages 202, the load time for each page 205, the time spent by the user using or reading the page 204, and additional “local events” that help to understand the exact nature of the user's web usage and behavior.

In one embodiment, local events may be denoted by icons or symbols explaining the user behavior. For example, the icon shown at 208 symbolizes the link that the user used to enter in a page that belongs to the list of monitored or selected web sites. A different icon may indicate that a user has opened a new browser window. The icon shown at 210 may indicate that the user aborted the loading process, or changed link towards another page before the current page is fully loaded. The icon at 212 may indicate that the user typed in a new URL to enter a page instead of using a hyperlink. The icon shown at 214 may indicate the link that the user used to navigate to a page that does not belong to the list of monitored web sites. The icon shown at 216 may indicate that the user printed the current page. The icon shown at 218 may indicate that a page was refreshed manually by user. The icon at 220 may indicate that the user scrolled to see hidden part of a loaded page. Another icon may indicate that a user spent more than an average time to look at the page. The icon at 222 may indicate that this page had above average load time. The icon at 224 may indicate that the user reached the page by clicking on a link. The icon at 226 may indicate that the user pressed or selected “back” or “forward” browser navigation functions to navigate to previously loaded web pages.

In one embodiment of the present invention, the agent software installed on a user workstation may play an active role. That is, the agent is not just a monitoring program that is buried or hidden. Instead, the agent may be visible to the user. For example, the agent may be a small program that executes on the user's device e.g., a PC desktop, offering a set of menu items that may be manipulated by the members of an observation panel. As described above, the observation panel includes a set of users that agreed to being monitored, e.g., to download and install the agent from a web site, portal, or service providing the system of the present invention.

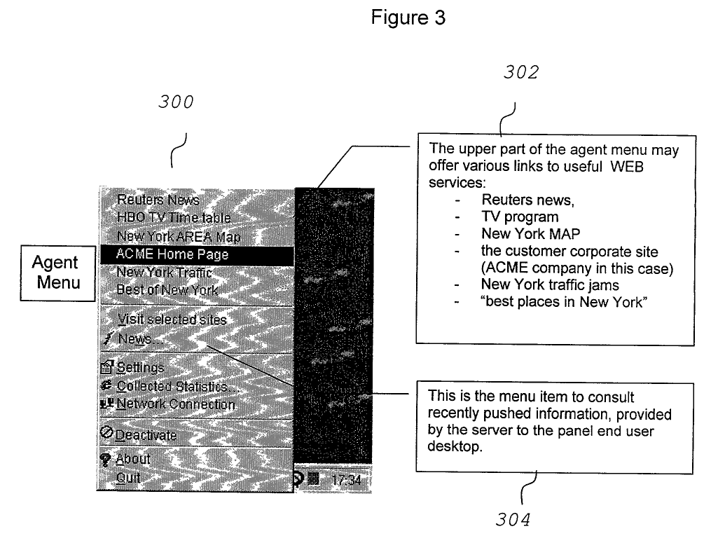

FIG. 3 illustrates an example of a pop-up menu 300 displayable on the user device having the agent software. A set of menu items in the agent menu 300 may optionally allow a user to directly access a selected entry point into specific areas of a selected web site as shown at 302. These specific areas may have been determined by the entity receiving the monitored information.

In one embodiment, the agent may optionally offer an information push service, i.e., information provided to the user without the user first requesting it. For example, the menu 300 also may include a link 304 to various information that the server may have pushed to the user device. This way, information may be communicated to the user without the user having to actually visit any of the selected web sites. An organization posting the push information, e.g., a panel owner organization who initiated the panel study, i.e., the monitoring, does not need to know the exact addresses of the users to whom they would like the information to be conveyed, e.g., since the information push may be handled by the agent software and/or the server in the present invention. Consequently, the users remain anonymous, but remain posted with important information such as the company promotions, alerts, critical facts, disruption of service, etc. without having to visit the web site of this company. When a user selects any one of the items on the menu 300, the agent software opens a new browser window and loads the selected service if a browser window is not already opened or unavailable.

In one embodiment, the users that belong to the observation panel may receive the same notification of pushed information, for example, by using the menu 300 and selecting the news item 304 on the menu 300. The users may then be directed to a web site for additional information. Because the present invention allows useful web services to be offered to the panel members, i.e., web users who have agreed to be monitored when the users visit the selected web sites, without having to directly associate with the web users, a corporate entity receiving the monitored information may be able to build a stronger relationship with members of its user panel while at the same time preserving the users'anonymous status.

As described above with reference to FIG. 1, the collected information may be stored in a database. The present invention also may include an analysis module that data mines this database to build information reports on various areas of interests. Example of these interests may include evolution of panel audience among various monitored sites, detailed analysis to determine how and when users enter and exit web services, high level audit of web sites and services to quickly determine defaults in web site that trigger abnormal user navigation behavior. The analysis module may be configured to run automatically or periodically as desired.

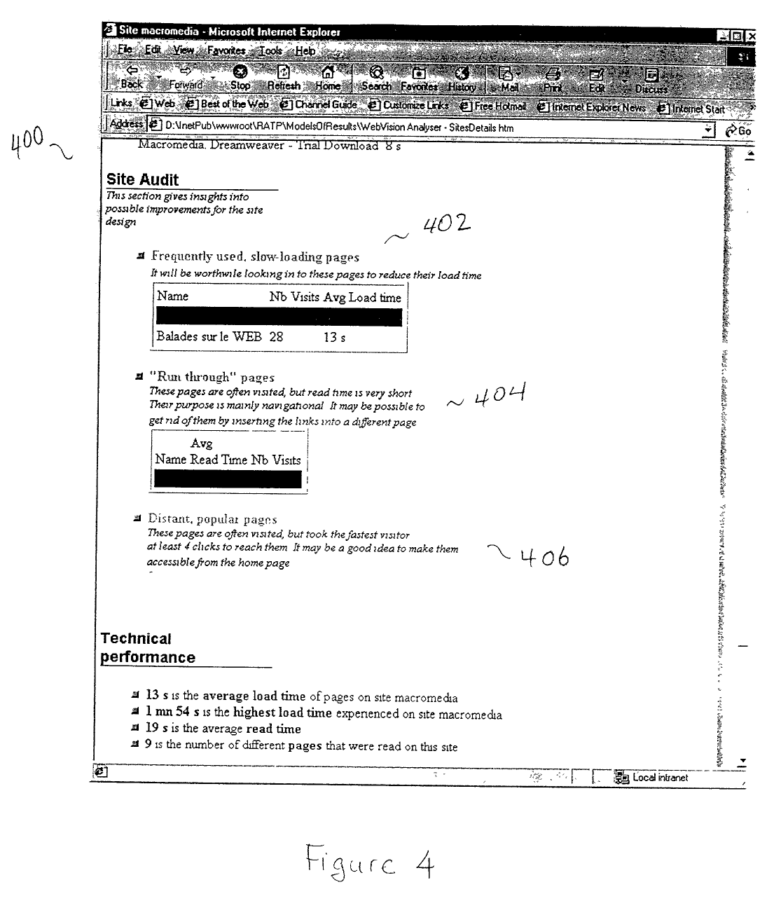

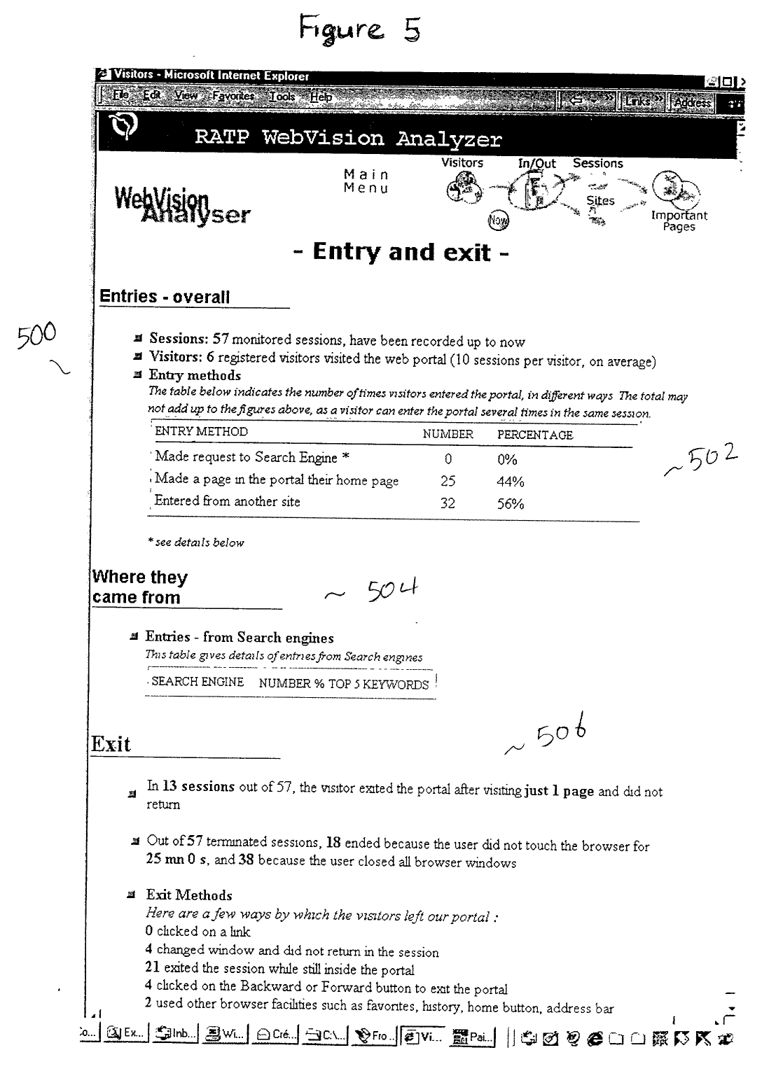

In one embodiment, the analysis module produces results and information reports, preferably in the form of web pages. The web pages may then be distributed to the entities requesting such information. FIGS. 4 and 5 are examples of the web page reports generated by the present invention in one embodiment. In FIG. 4, the report 400 shows frequently used but slow-loading pages 402, pages visited in a short amount of time 404, and pages that are frequently visited but are deeply embedded in a web site 406. This information would be useful, for example, to businesses hosting the web site to bench mark and better service their users.

FIG. 5 is another example of a report produced in the present invention. The report 500 includes the entry and exit information of a web page. For example, statistics on how the users entered the page are tabulated at 502. The methods of entry may include via a search engine, via a home page, or directly from another site. At 504, the report 500 also shows detailed entries from search engines. At 506, a detailed report on how a user exited the web page is also shown. The exit method reported may include how a web page session terminated, and which navigation button was clicked or selected to exit the page.

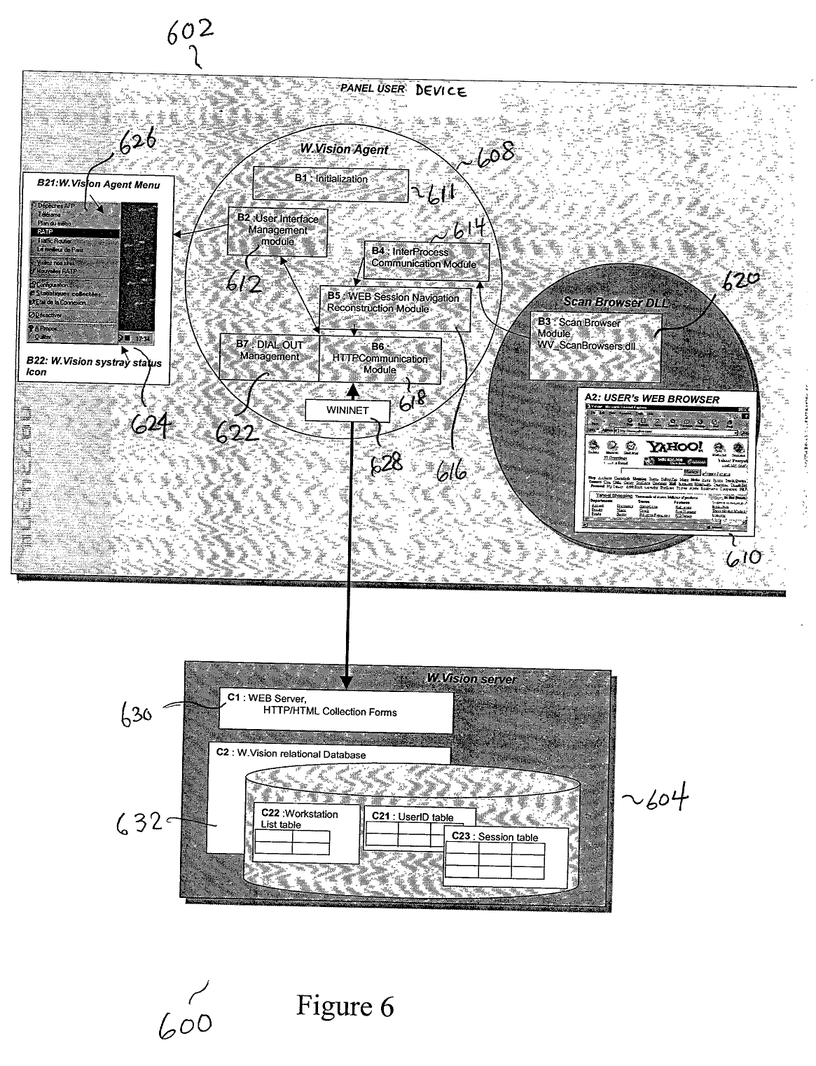

FIG. 6 illustrates the design architecture of the system of the present invention in one embodiment. Throughout the description, the panel user device 602 refers to a device with the agent software running or installed. A user being monitored is referred to as a panel user. The present invention is enabled to support one or more panel users. The panel users typically operate a web browser 610, e.g., an Internet Explorer(®) or Netscape(®), on their devices to access the web.

The agent 608 of the present invention resides in the panel user device 602 and may, in one embodiment, include a number of modules interacting with one another. The initialization module 611 creates an agent executable main thread, and initiates the general hooking mechanism to the web browser 610. The hooking mechanism enables the scan browser dynamic link library (“DLL”) module 620 to start as soon as the web browser 610 is launched by the panel user. The initialization module 611 also starts an interprocess communication module 614 and a HTTP communication module 618, and initializes the configuration of the agent module 608 by launching the web navigation reconstruction module 616. The initialization module 611 also starts a user interface management module 612 for handling graphical user interface (“GUI”) accessed by the panel user.

The user interface management module 612 generally monitors user actions and displays a status icon referred to as a “systray status icon” 624 in the user display window. The systray status icon 624 may include an “active” icon state, “inactive” icon state and “observing” icon state. The icon states denote what the panel user is doing with the web page at that time. If the panel user clicks on one of the icon states on the systray status icon 624, the user interface management module 612 starts an agent menu 626 which offers various option items configured for the panel user. Example of these option items may include stopping the agent, disabling/enabling the agent, consulting collected statistics, reading connection status, consulting configuration of the monitored web sites, and accessing to specific URLs of interest or recently pushed information.

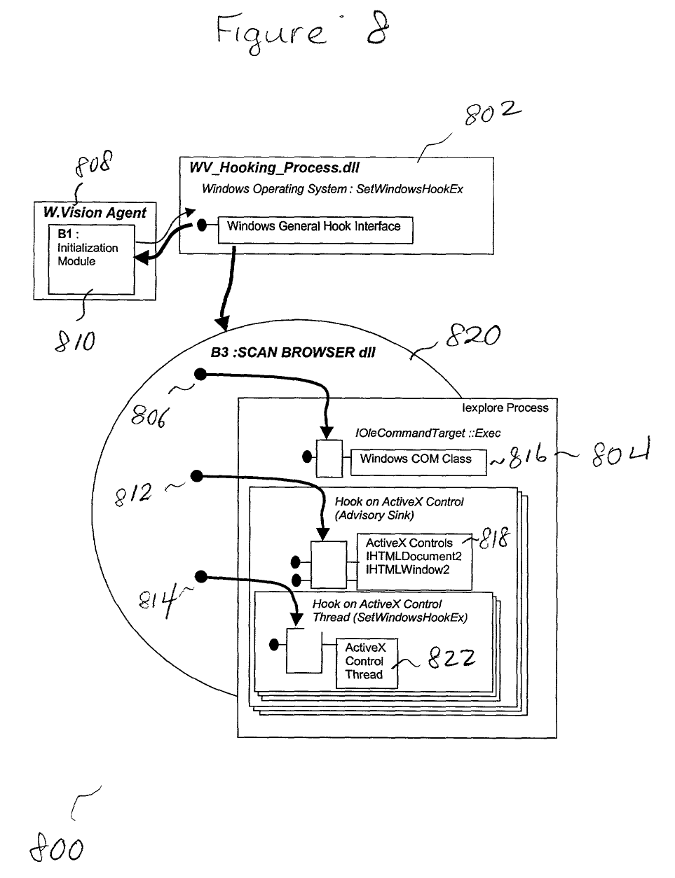

The scan browser DLL module 620 hooks and scans events occurring in each web browser instance 610 running on the panel user device 602. The scan browser DLL module 620 spies and gathers individual actions and events. In one embodiment, the scan browser DLL module 620 is implemented to execute itself in the web browser process addressing space. The agent module 608 via the initialization module 611 injects the scan browser DLL module 620 with its hooking technique. The hooking technique will be described in greater detail with reference to FIG. 8. Referring back to FIG. 6, the scan browser DLL module 620 in one embodiment does not execute in the agent process's addressing space, i.e., the scan browser DLL module 620 is injected into the browser process's address space. The communication module 614 is used by each instance of the scan browser DLL module 620 to pass collected information to the main agent process 608. The scan browser DLL module 620 filters and reconstructs elementary user interface events occurring on the corresponding web browser 610 by using an algorithm known as the elementary scenario recognition algorithm. An exemplary implementation of this algorithm will be described in greater detail herein below. When the elementary scenarios are recognized, they are passed to the interprocess communication module 614 for further analysis by the session reconstruction module 616. In one embodiment, the web session navigation reconstruction module 616 may be located in the agent 608 process address space.

The interprocess communication module 614 allows each scan browser DLL module 620 to communicate monitored information to the agent 608 in a form of elementary scenario measurements. The interprocess communication module 614 passes the information received to the web session navigation reconstruction module 616 for processing and analysis of user session-level detailed navigation and web browser user interaction. The web session navigation reconstruction module 616 filters and reassembles the elementary scenario measurements on a session per session basis to provide coherent user browsing history on each monitored web page. In one embodiment, the elementary scenario measures are implemented in a global first-in-first-out (“FIFO”) buffer to serialize the occurrence of the events.

The HTTP communication module 618 generally handles the connection with the server 604. For example, the HTTP connection may be built on top of the WININET API 628 when the device is WINDOWS based. In one embodiment, the HTTP communication module 618 sends the reconstructed session level measurements to the server 604. The HTTP communication module 618 also may serve to retrieve various configuration data from the server 604.

The dialout management module 622 may be utilized to control dial out calls that may occur automatically when the agent 608 needs to communicate with the server 604, e.g., in cases where the device is connected via a modem to public telephone network. The dialout management module 622 detects any dialout popup window or dialout process occurring automatically in a thread of the HTTP communication module 618 and can abort a dialout process when it is detected that the panel user has terminated a phone modem based Internet/ISP session.

The server 604 receives the reconstructed session-level measurements from one or more agents 608 distributed over the Internet, Extranet, and/or Intranet, e.g., in a form of HTTP Post requests. The server 604, in one embodiment, may provide URLs on HTML FORMS that the agent 608 can request in HTTP POST mode, e.g., to update the database 632 with new reconstructed session-level measurements and/or to retrieve its configuration, e.g., the list of web sites to be monitored, from the database 632.

The database 632 provides the server module 630 with a data repository to gather and store the measurements transmitted from the various deployed and active agents 608. In one embodiment, the database may be implemented as a SQL database. The database may also be implemented using flat or sequentially indexed files that provide a facility to store and retrieve a collection of time-stamped identifiable measurements.

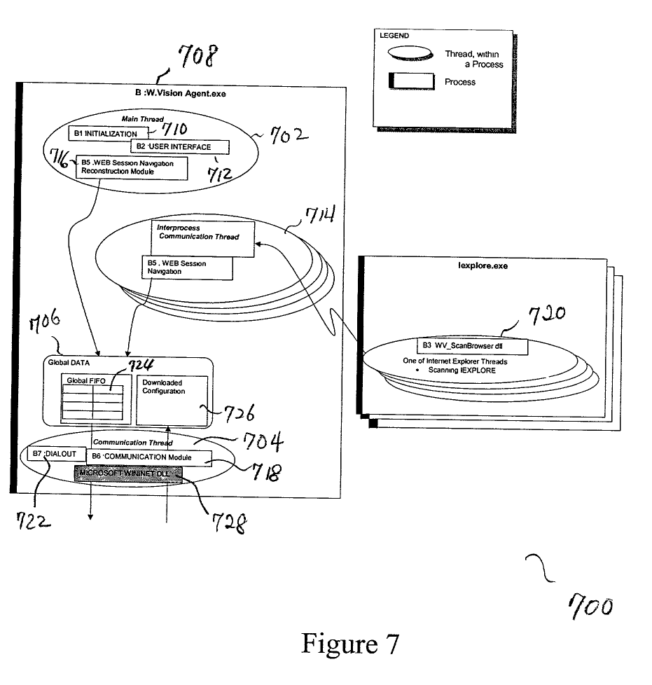

FIG. 7 illustrates a multi-threaded architectural design 700 of the present invention in one embodiment. In describing the present invention with reference to FIG. 7, Internet Explorer(®) web browser is used as an example, however, it should be understood that any other interfaces may be utilized and that Internet Explorer (®) is used as an example only. One or more scan browser DLL threads 720 are hosted on each user's active browser, e.g., the Microsoft Internet Explorer(®) web browser, utilizing the ActiveX control interfaces and associated threads. The agent 708 includes one instance or thread 714 of the interprocess communication module per instance of the scan browser DLL 720. The agent main thread 702 hosts the initialization module 710 as well as the user interface management module 712 and uses the web session navigation reconstruction module 716 to initialize, retrieve and interpret configuration data received from the communication module.

The communication module thread 704 generally handles the connection with the server and may include a dial out module 722 and communication module 718, and loads Microsoft WININET DLL 728, e.g., to offer HTTP-based connection to the server. The agent 708 may also include a global data area 706 where reconstructed session-level measurements may be stored in a FIFO buffer 724, e.g., to be sent to the server by the communication thread 704. The global data area 706 may also store configuration data 726 received from the server. Examples of configuration data include list of web sites to be monitored for this user, etc.

FIG. 8 is a block diagram illustrating the hooking mechanism in one embodiment of the present invention to spy and collect navigation information from each running browser process. The initialization module 810 in the agent 808 sets a general hook, e.g., in the Windows Operating system. The WV_Hooking_Process DLL 802 is installed using, e.g., Microsoft Windows SetWindowsHookEx API. This WV_Hooking_Process DLL is used as an “injection mechanism” of the scan browser DDL module 820 which “observes” or monitors work in the web browser application.

For each WINDOWS process started, the WV_Hooking_Process DLL 802 is called automatically by the operating system. The call-back function of the DLL does nothing and immediately returns code OK. When called at startup of any WINDOWS process, this DLL checks whether the current process is a web browser process. If the current process is a web browser process, the scan browser DLL module 820 is launched by the WV_Hooking_Process DLL 802 in the address space of the detected web browser process.

The scan browser DLL 820 creates 3 new types of hooks. A first hook 806 takes place on the Microsoft Windows COM Class 816, via the IOleCommandTarget::exec WINDOWS API call. The purpose of this hook is to be registered for receiving events and messages from the Internet Explorer (“IE”) Process, i.e., the web browser process 804. This hook 806 is also able to discover ActiveX control instances 818 embedded in the IE process 804, and to put a hook on them. A second hook 812 type takes place on the IHTMLDocument2 and IHTMLWindows2 Microsoft IE ActiveX controls. This second hook 812 is implemented using Windows(®) “Advisory Sink” hook mechanism. The purpose of the second hook 812 is to retrieve information from inside the HTML document. One hook advisory sink is implemented per discovered ActiveX control instance via other hook instances. The ActiveX control instance may correspond to an individual web page “frame”.

A third hook type 814 takes place on each ActiveX control thread 822, using e.g., SetWindowsHookEx WINDOWS API. The purpose of this third hook 814 is to be registered for receiving events and messages from the Hooked ActiveX Control thread dedicated to GUI management. One hook of the third type 814 may be implemented per discovered ActiveX control thread instance (720 FIG. 7).

In the present invention, the scan browser DLL 820 may be started after a pre-existing web browser, e.g., IE web browser process, and enabled to start scanning or observing events “on the fly”, without a need to restart the web browser process. In one embodiment, the scan browser DLL 820 retrieves a large set of low level system events and messages related to HTML document status and related GUI activities. The events and messages related to HTML document status may include URL, page loaded, requested, refreshed, etc. The related GUI activities may include mouse clicks, keyboard keystrokes, scrollbars usage, etc.

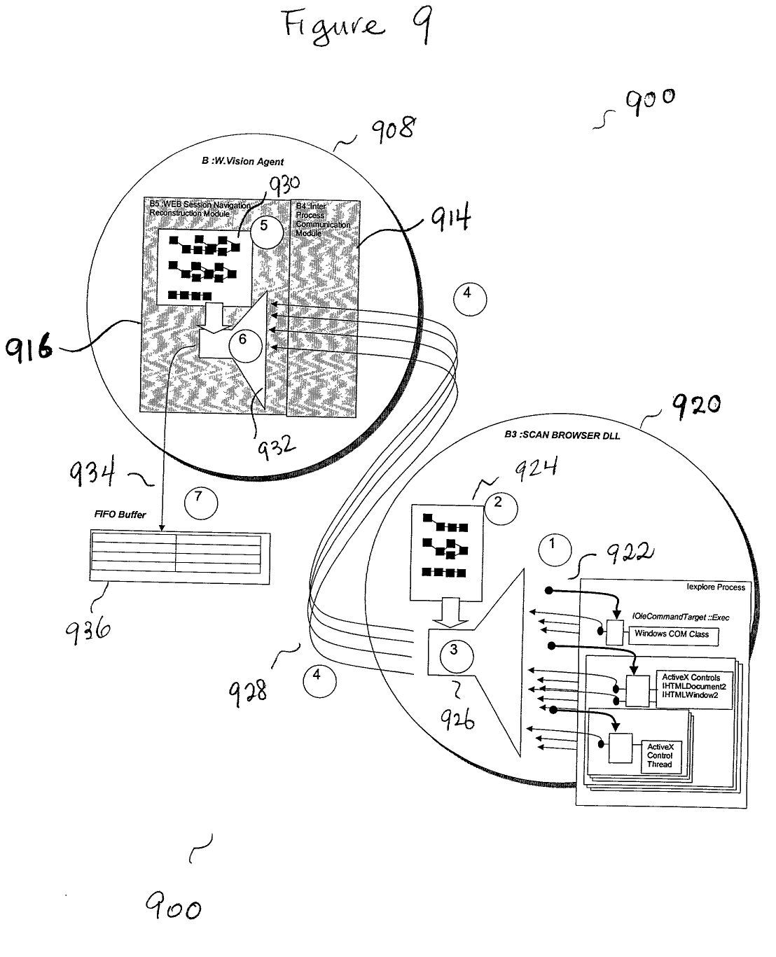

The collected information may then be interpreted, e.g., by using a navigation scenario recognition or analysis algorithm. FIG. 9 is a block diagram 900 illustrating the analysis algorithm in one embodiment of the present invention. The algorithm may be used to build a high level descriptive history of user behavior or web usage from low level GUI basic event and object interactions such as frames, mouse clicks, resizes, inactivities. In one embodiment, the high level descriptive history may be built per web browser session, i.e., from the time the user opens a web browser until the time the user closes or exits the web browser.

In one embodiment, the algorithm involves continuous and dynamic analysis of the low level measurements, or events, and is divided into two component parts. One part runs in the web browser process as an injected module, scan browser DLL 920. The other part runs in the session navigation reconstruction module 916 of the central agent 908. As shown at 922, with the hooks of the present invention implemented, the scan browser DLL 920 retrieves a set of low level system event and messages related to HTML document status such as URL, loaded, requested, refreshed, and related to the GUI activity such as mouse clicks, keyboards, scrollbars interaction, etc. . . . As shown at 924, the scan browser DLL 920 includes a module to describe the “elementary scenarios” collected. An “elementary scenario” is a logical sequence of such low level events correlated to one another within a predetermined order or time.

For example, an elementary scenario that reflects a basic web link navigation may include the following: detection of a user mouse click on a web page frame hyperlink; “stop” notification of the corresponding frame, e.g., the browser aborts current URL download, to implement a new click navigation, frame destruction detection; new frame activation notification. Such a sequence of expected low level events that can be monitored by DLL 920 indicates that the user switched to another web page by clicking on a hyperlink located in the previous web page.

At 926, an automata machine, e.g., may be used to parse and search for a matching elementary scenario, while receiving the flow of low level events and messages. The matching elementary scenario refers to an occurring sequence of low level events that match a predefined sequence, i.e., the scenario. The matched elementary scenarios are passed as shown at 928 to the central agent 908 for further analysis.

In one embodiment, the web session navigation reconstruction module 930 receives the elementary scenario measurements via the interprocess communication module 914 and builds a structure to describe “session level” scenarios. A “session level” scenarios is a logical suite of elementary scenario measurements, correlated with one another, e.g., according to a time order. The web session navigation reconstruction module 930 also may include an automaton to parse and search for a matching session level scenario while receiving the flow of already matching elementary scenario observation. The output session level scenarios may be stored in the FIFO buffer 936 for transmission to a server. Table 1 is a list of examples of the session level information output by the navigation reconstruction module 930.

TABLE 1

| Symbol | Session Level Scenario Description |
|---|---|
| [symbol] | Page not completely loaded |
| [symbol] | Page was printed |
| [symbol] | Pages scrolled up or down |
| [symbol] | Page was refreshed |
| [symbol] | Page was automatically refreshed or redirected |
| [symbol] | A Page transition takes places by typing a new page URL |
| [symbol] | The user navigates out of the actual monitored web site(s) |
| | by clicking on some explicit link in the page. Destination |
| | site is displayed if cursor stays on this icon for a while |
| [symbol] | The user navigates into some of the monitored site(s) by |
| | clicking on some explicit link. Origin site is displayed if |
| | cursor stays on this icon for a while |
| [symbol] | Page read time by user is important (different from page |
| | load time !) |
| [symbol] | Page load time is long |
| [symbol] | The user opened a new Browser window |
| [symbol] | The user clicked on a link, directly in the page |
| [symbol] | The user pressed back or forward browser buttons |
| [symbol] | The user switched from one open browser window to |
| | another |
| [symbol] | The user opened a new window using the file + new |
| | window browser function |
| [symbol] | The user closed a Browser window |
| [symbol] | Some Browser window became top active window again |
| [symbol] | User uses keyboard or mouse after the inactivity delay |

Referring back to FIG. 1, the agent 106 may be deployed over a panel of user workstation 108 while preserving the identity of the user that agrees to run the agent and to send collected information to the server 118. That is, the privacy of the user may be completely protected. The preserving of the user identity in one embodiment of the present invention is achieved by using an anonymous identifier (“ID”) for each user agent for every communication session such that no further identification of the user is necessary when transmitting the collected information to the server 118.

In one embodiment, this user identification protection scheme is implemented by defining three main tables in the server database 120. The first table is referred to as a user ID table. For each user that is part of the user panel 104, a unique non-interpretable ID is allocated by the server 118. The ID may be an integer value. The first table structure includes 3 following fields: user anonymous ID; date and time of the first connection of the user agent to the server; and date and time of the last or most recent connection of the user agent to the server. An example of a row instance in this table is:

<6545/Oct. 28, 2000 14:05:00/Oct. 30, 2000 18:08:07>

The second table is referred to as a workstation list table. For each user device that is part of the active panel, a new row is created in this table by the server 118. The workstation list table structure includes seven fields: workstation ID; browser type; browser version number; operating system version; date and time of first user session; date and time of last or most recent user session; agent version number. An example of a row instance in this table is:

<45637/IEXPLOR/5.00.2014.200/0x565004/Oct. 2, 2000 09:00:00/Oct. 30, 2000 18:00:00/1.0.1>

The third table is referred to as a session table. For each user that is part of the user panel 104, for each session using its web browser, i.e., the time between the opening and closing of a web browser, a new row is created in the session table by the server 118. The session table includes five fields: session ID; user anonymous ID; date and time of session start; session duration; pointer on all information collected during the user session. The pointer may be to another table having the information.

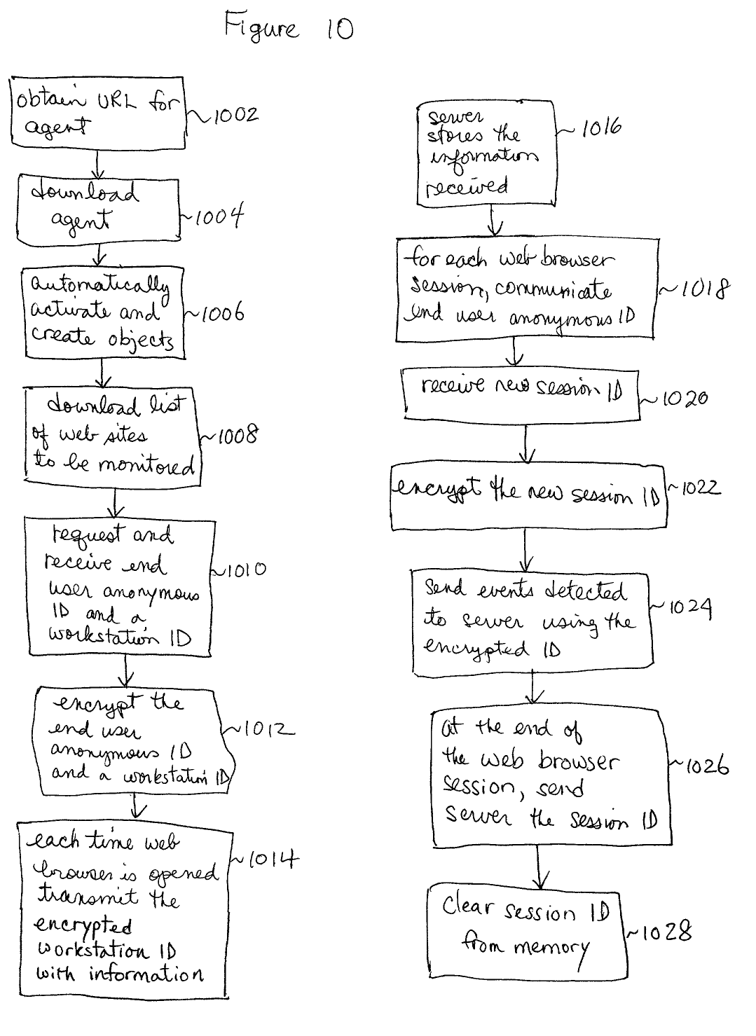

The description of the process of allocating an anonymous user ID using the above-described tables will now be described in greater detail with reference to FIG. 10. FIG. 10 is a flow diagram describing the process of allocating an anonymous user ID in one embodiment of the present invention. At 1002, the user obtains a URL link from where an agent program or software may be downloaded, by for example, browsing different web sites on the Internet. At 1004, the user decides to be part of the user panel and using the link obtained at 1002, the user installs the agent on the user device. The user device, for example, is a personal computer with Microsoft Windows and a Internet Explorer(®) web browser. The downloaded agent program includes the URL to a server to which the agent is to send its collected information. The server as described above may include a database to store the collected information. At 1006, once the agent is installed, it is activated automatically. Alternatively, the download and/or the automatic installation steps may be bypassed if the device already has the agent installed.

The agent creates user interface objects such as a menu or a tool bar (e.g., 624, 626 FIG. 6), and at 1008 if the Internet connection is opened, the agent downloads from the server database the list of web sites to be monitored. If the Internet connection is not opened at the time the agent is installed, the agent downloads the list of web sites the next time the Internet connection is opened. The user may consult this list of observed or monitored web sites using the agent's user interface menu.

At 1010, the first time the user browses one of the monitored web sites, the agent requests an “end user anonymous ID” and a “workstation ID” from the server. The server replies with these two new Ids. At 1012, the agent encrypts the received IDs using any one of the known encryption algorithms. The agent stores the Ids, e.g., in the WINDOWS REGISTRY, the user anonymous ID under HKEY_CURRENT_USER key, and the workstation ID under HKEY_LOCAL_MACHINE key.

At 1014, each time the user opens its web browser application, the agent sends the workstation ID as stored under the HKEY_LOCAL_MACHINE key, information about the user workstation operating system type, version number, browser type, browser version number, and the agent version number. The server receives this information and stores the information in its workstation list table at 1016. At 1018, at the beginning of each web browser session, the agent sends the user anonymous ID as stored under HKEY_CURRENT_USER key to the server. The server replies back with a new session ID to be used by the agent for this new current session.

At 1020, the agent receives the new session ID and at 1022, encrypts the new session ID using any known encryption algorithms. The encrypted new session ID is then stored in the WINDOWS REGISTRY under the HKEY_LOCAL_MACHINE key. At 1024, each time the agent detects a user session-level scenario in the navigation, it send the session ID for this current session and the navigation collected information to the server. At the end of the web browser session, the agent sends the session ID to the server at 1026. The server replies back and the agent clears the session ID in the WINDOWS REGISTRY under the HKEY_LOCAL_MACHINE key at 1028.

At any point in time, the user may visualize the information collected during the current and past navigation sessions by using the agent interface menu (624, 626 FIG. 6). Upon such a request from the user, the agent requests from the server the information collected so far. The server replies back with the information related to the session stored in the database. The agent receives, formats and displays this information in, e.g., a dialog box window.

As described above, the present invention allows an entity to study web user behavior over a list of pre-defined or selected web sites; to recruit web users to take part in the study, e.g., the users taking part of the study are referred to as panel users; and to propose incentives to the panel users by providing web services to be accessed by the panel users via the agent menu, including news services provided to the panel users by a push mechanism.

In one embodiment, a user may become a part of multiple panels. For example, a first entity may solicit the user to become part of its panel. If the user agrees, the first entity provides a list of web sites for which the user's usage will be monitored and collected. A second entity also may solicit the same user to become part of its panel. The second entity also provides its list of web sites for which the user's usage will be monitored and collected. The user may thus become a member of multiple panels in the present invention. The web sites in the first entity's list and the second entity's list may overlap.

FIG. 11 illustrates a panel configuration 1100 in one embodiment of the present invention. A typical agent software package 1101 downloaded on a user device includes an executable agent software 1120, the URL of a server 1102 that the agent will use to communicate the monitored information. The agent software package 1101 may optionally include any customized information 1103, e.g., icons, GUIs and logos referring to the identity of the entity initiating the panel study. A server typically handles one or more different panel configurations 1100. For a panel configuration, the server provides the agent with a list of web sites to be monitored 1105, a menu setting configuration 1106, e.g., the list of URL to access to various on line web services of interest such as “REUTERS news”, “NEW YORK City map” (FIG. 3, 302), news settings 1107 for information push, e.g., the URL of the pushed news page, or the title of pushed page. Since the behavioral information is collected for several different web sites, entities other than the one that initiated the panel study may also be provided with the information. In addition, an agent may communicate or work with more than one server in initiating and providing the behavioral information of a web user. Furthermore, a panel user may become a member of more than one panel as described above. The additional panels may be handled by the same server or by another server. Consequently, an agent running on a user device may handle monitoring of one or more lists of web sites, each list corresponding to one panel study. Similarly, one or more servers may handle one or more agents running on user devices. Further yet, one or more servers in the present invention may handle one or more agents running one or more panel studies, i.e., one or more lists of web sites being monitored for one or more entities who each initiated the panel study.

In one embodiment, when a user who is a member of at least one panel also downloads another agent software package 1101 as a result of becoming a member with another panel, the latest version of the executable agent is kept on the user device. Alternatively, different agent package version may run in parallel, e.g., for compatibility reasons. To maintain the agent footprint on machine resources as low as possible, only one instance of the agent 1120 may run on a user device and still be able to handle multiple panels.

The agent running on a user device may handle and run the different panel configurations 1100 from one or more servers. That is, in the present invention, the server may be a central server or one or more distributed servers. In one embodiment, the agent monitors a list of web sites which are the aggregation of lists of monitored web sites 1105 for each panel configuration 1100. The user who is part of multiple panels typically has access to all the menus 1106 and the news push information 1107 provided by each individual panel configuration 1100.

The same user may be identified by one or more servers with different anonymous IDs if that user is a part of multiple panels.

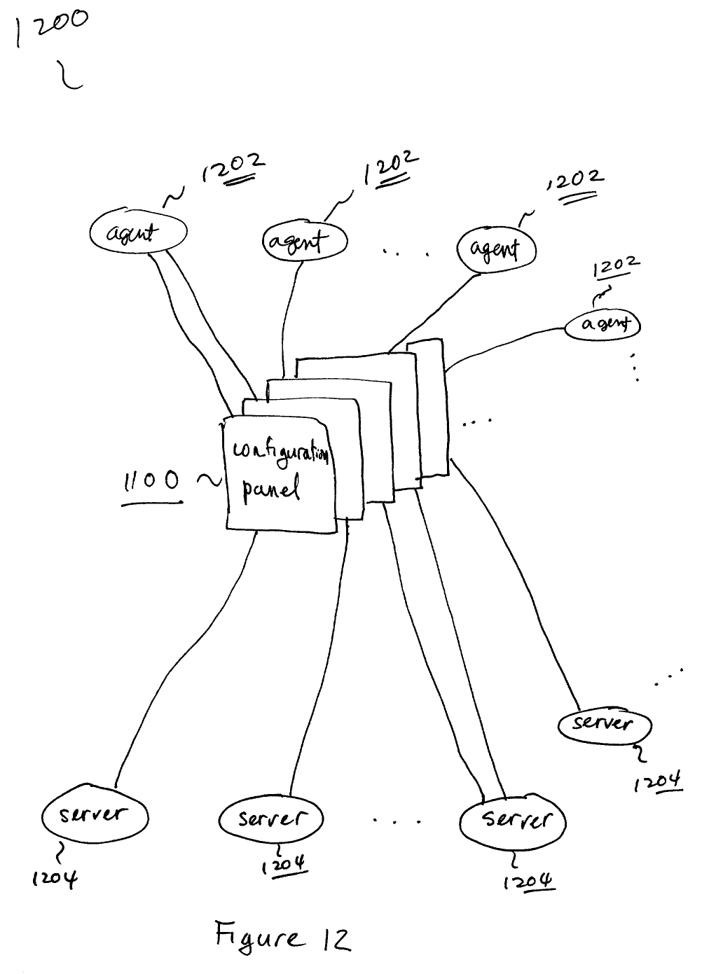

FIG. 12 illustrates an example schema 1200 of one or more servers and one or more agents handling one or more panel configurations. One or more servers 1204 may communicate with one or more agents 1202 to handle one or more configuration panels 1100. Shown by examples in FIG. 12, one server 1202 may service more than one agent 1202. One agent 1202 may service more than one configuration panel and/or communicate with more than one server 1204 to handle the one or more configuration panels. In addition, other combinations of agent-configuration panel-server coupling may also be possible. Accordingly, it should be understood that the coupling shown in FIG. 12 is for example only and the present invention should not be limited to the one shown in FIG. 12.

The present invention enables the user who is a member of multiple panels to access the customized icons, GUIs and logos 1103 of each panel configuration 1100 individually via distinct icons displayed in the systray, or all at the same time via a single icon giving access to an overall menu.

While the invention has been particularly shown and described with respect to a preferred embodiment thereof, it will be understood by those skilled in the art that the foregoing and other changes in form and details may be made therein without departing from the spirit and scope of the invention.

We claim:

1. A method for providing behavioral information of a user using on-line resources, comprising:
collecting behavioral information of a user using resources over a network;
analyzing the collected behavioral information; and
providing an analysis of the collected behavioral information.

2. The method of claim 1, wherein the collecting includes:
collecting behavioral information of a user using resources over a network, the user having given a permission to being monitored.

3. The method of claim 2, wherein the method further includes:
providing one or more incentives to the user to give the permission to being monitored.

4. The method of claim 3, wherein the one or more incentives include any one or combination of news, television program schedule, a map of a selected area, transportation information, and area information.

5. The method of claim 1, wherein the resources include one or more services offered on the World Wide Web, and the method further includes:
providing one or more lists of web sites for monitoring,
wherein the behavior information is collected only on the one or more lists of web sites.

6. A method for providing behavioral information of a user using one or more web services, comprising:
monitoring user behavior on a web browser when a user visits a predetermined set of web sites;
allowing the user to consult the monitored user behavior; and
transmitting the monitored user behavior over a network to one or more servers.

7. The method of claim 6, wherein the monitored user behavior includes any one of method of entry, method of exit, time spent, loading time, response time, and user interface events detected during navigation of a web page.

8. The method of claim 6, wherein the transmitting includes transmitting the monitored user behavior over a network to one or more servers using one or more anonymous identifiers, wherein actual identity of the user is preserved.

9. A method for providing behavioral information of a user using one or more web services, comprising:
recruiting a user to be monitored for one or more predetermined web sites;
collecting behavioral information of the user when the user visits the one or more predetermined web sites; and
providing the behavioral information.

10. The method of claim 9, further including:
obtaining the predetermined web sites for monitoring from an entity, and the providing includes providing the behavioral information to the entity.

11. The method of claim 8, further including:
allowing the user to install an agent for monitoring on a user device.

12. A system for providing behavioral information of a user using one or more web services, comprising:
an agent residing on a workstation identified with a user who has agreed to be monitored, the agent responsive to the user browsing a predetermined web sites, collecting behavioral information of the user; and
a server operable to receive and store the behavioral information of the user.

13. The system of claim 12, further including:
a database for storing the behavioral information of the user.

14. The system of claim 12, wherein the agent further includes a user interface to provide the user with the behavioral information.

15. The system of claim 12, wherein the agent further includes a user interface to provide the user with resourceful information.

16. The system of claim 15, wherein the resourceful information includes any one of news, television program schedule, a map of a selected area, transportation information, and area information.

17. The system of claim 12, wherein the server further includes an analyzer operable to analyze the behavioral information.

18. The system of claim 17, wherein the analyzer further provides a report based on the analysis of the behavioral information.

19. The system of claim 12, wherein the behavioral information includes one or more input/output events on a web page.

20. The system of claim 19, wherein the one or more input/output events on a web page includes any one of mouse clicks, mouse scrolls, mouse movements, and keyboard input.

21. A program storage device readable by machine, tangibly embodying a program of instructions executable by the machine to perform method steps of providing behavioral information of a user, comprising:
collecting behavioral information of a user using resources over a network;
analyzing the collected behavioral information; and
providing an analysis of the collected behavioral information.

22. The program storage device of claim 21, wherein the method step of collecting includes:
collecting behavioral information of a user using resources over a network, the user having given a permission to being monitored for the collecting.

23. The program storage device of claim 21, wherein the resources include one or more services offered on the World Wide Web, and the method steps further include:
providing one or more lists of web sites for monitoring,
wherein the behavior information is collected only on the one or more lists of web sites.

24. A program storage device readable by machine, tangibly embodying a program of instructions executable by the machine to perform method steps of providing behavioral information of a user, comprising:
monitoring user behavior on a web browser when a user visits a predetermined set of web sites;
allowing the user to consult the monitored user behavior; and
transmitting the monitored user behavior over a network to one or more servers.
